(19) United States
(12) Patent Application Publication
(10) Pub. No.: US 2005/0254242 A1
(43) Pub. Date: Nov. 17, 2005

(54) Action light system -- decorative lighting

(76) Inventor: Claude W. Baker, Rockford, IL (US)

Correspondence Address: KEITH FRANTZ, 401 WEST STATE STREET, SUITE 200, ROCKFORD, IL, 61101, US

(21) Appl. No.: 11/090,902

(22) Filed: Mar. 24, 2005

Related U.S. Application Data
(60) Provisional application No. 60/555,875, filed on Mar. 24, 2004.

(51) Int. Cl. F21V 21/00

(52) U.S. Cl. 362/249; 362/252; 362/391

(57) ABSTRACT

A light system provides a visual effect and impression of motion of objects, and in particular the rising and falling of objects, through the sequential lighting of an array of individually controllable lights. The embodiments disclosed herein are, for example, a light array to simulate the action of an icicle dripping water and an array to simulate a rising and exploding firework shell. These arrays and the driving means are arranged in such a manner as to implement the actually physical equations of motion to enhance realism. This is accomplished by appropriate timing and spatial positioning of the individual lights, or a combination thereof.

### CROSS-REFERENCES TO RELATED APPLICATIONS

This application claims priority to and the filing date benefit of U.S. Provisional Patent Application Ser. No. 60/555,875, filed Mar. 24, 2004.

### INCORPORATION-BY-REFERENCE OF MATERIAL SUBMITTED ON A COMPACT DISC

Not Applicable.

### STATEMENT REGARDING FEDERALLY SPONSORED RESEARCH OR DEVELOPMENT

Not Applicable.

### BACKGROUND OF THE INVENTION

1. Field of Invention

The present invention relates generally to decorative lighting.

More particularly, the invention relates to a lighting system configured to provide the visual effect of an object in motion through sequential lighting of an array of individually controllable lights. The invention is especially configured for implementation of a falling or rising object with the accelerating and decelerating effects of gravity.

2. Description of Prior Art

Decorative lighting is well known. People have been decorating their homes, yards, parks and other locations for years with many types of decorative lighting. The most common types of decorative lighting are used in various holiday seasons.

For example, certain types of various lighting and related items are shown in U.S. Pat. No. 6,086,222 for Panel Cascade Effect Icicle Light Sets, U.S. Pat. No. 4,417,182 for Moving Flutter Illusion Electric Light Controller, U.S. Pat. No. 5,747,940 for Multi-dimensional Control of Arrayed . . . , U.S. Pat. No. 5,975,717 for Cascade Effect Icicle Light Set, U.S. Pat. No. 6,050,701 for Decorative Lighting System, U.S. Pat. No. 6,072,280 for Led Light String Employs . . . , U.S. Pat. No. 6,179,647 for Light Set Arrangement, U.S. Pat. No. 6,224,239 for Decorative Lamp Fixture . . . , U.S. Pat. No. 6,398,387 for Icicle Light Candy Cane, U.S. Pat. No. 6,494,591 for Ornamental Lighting Device, U.S. Pat. No. 6,634,766 for Ornamental Lighting, and U.S. Pat. No. 6,491,019 for Preferred Embodiment to LED Light String.

Of recent years, use of holiday and decorative lighting has become increasingly popular, such as for people to show pride in home ownership. Many types of decorative lighting systems have become available, giving people the opportunity to decorate their homes in many unique and individual styles. Consequently, people are continuously seeking additional creative and innovative ways of showing that pride, and in providing unique visual effects to their homes, with unique decorative lighting. Accordingly, there is an ever present and currently increasing desire for new and unique lighting systems suitable for home and other decorative use. To that end, it would be desirable to obtain new and unique decorative lighting that provides an “action” effect. However, the concept of using lighting to display certain actions has never been effectively or fully achieved.

### SUMMARY OF THE INVENTION

The general aim of the present invention is to provide new and unique decorative lighting that provides a visual effect and impression of objects in motion through the sequential lighting of an array of individually controllable lights

Another aim of the invention is to utilize small lights or LEDs to “dance” in a programmed array as holiday decorations in a new and unique manner.

A detailed objective of the invention is to provide new and unique decorative lighting that simulates the rising or falling of an object with the corresponding decelerating or accelerating effect of gravity.

Another detailed objective of the invention is to provide new and unique lighting that produces a light “drop”, light blossom, light “explosion,” or similar effect when the simulated rising or falling objects reaches the end of its light path.

Yet another detailed objective is to provide the simulated rising or falling object with an appropriate simulated introductory light development effect prior to initiation of the rise or fall of the object.

These and other objectives and advantages of the invention will become more apparent from the following detailed description when taken in conjunction with the accompanying drawings.

The lighting concept of the invention is shown and described herein as two alternate holiday lighting systems, featuring a simulated falling object in the form of a melting icicle, and a simulated rising object in the form of a firework shell. The melting icicle drips “drops” of light which produce showers of smaller “droplets” of light upon reaching the ground. The firework shell rises from the ground to a point above where a simulated shell explosion produces a shower of light “sparks”. The effect of both basic embodiments is implemented as visually perceived moving points of lights. The concepts simulate a melting icicle with a culminating splash effect, and a firework shell igniting and exploding into a shower of brilliant lights.

One preferred falling object lighting unit features an icicle affixed to a gutter or some other point above the ground, with a visual melting effect and a forming droplet, such as simulated with a cluster of small lights affixed at the lowest point of the icicle, which appears to grow in to a larger droplet over a period of time. Upon reaching a desired size, the droplet appears to release from the icicle and fall towards the ground. This effect is displayed utilizing sequentially controlled lights. When the forming droplet reaches its desired size, the droplet-defining lights turn off and corresponding lights on a hanging stringed ribbon of lights turn on and then off in falling succession until an entire line of lights have all functioned. Upon reaching the end of the stringed ribbon wire of lights, a splash, exploding blossom, splatter, streamers, streaks, waterfall, frenzy, array, clusters, shower, spray, tear drop or similarly described effect is displayed again using sequentially illuminated lights. The splash, etc. effect starts at the center of a light blossom and cascades outward with individual lights lined on a multiplicity of outwardly flowing ribbon wires.

One preferred simulated rising object presents a rising and exploding firework shell, which operates similar to the simulated falling droplets of water, but with a reverse motion (rising) and a reverse simulated gravitational (decelerating) effect. The firework lighting unit features a simulated “wick” effect at ground level, a central ribbon of lights strung upwardly from the wick, and a blossom of stringed lights connected at the top of the central ribbon of lights at a location above ground. Lights in the wick are sequentially illuminated to simulate a constant “burn” until reaching the end of the wick. At that point, sequential illumination of lights in the central ribbon initiates relatively rapidly, and then slows as the simulated object rises, until reaching the upper blossom of lights which then simulates a shell “burst” through sequentially controlled illumination of the multiplicity of outwardly flowing ribbon wires in the light blossom at the top of the unit.

The preferred embodiments will utilize light emitting diodes (LEDs) to generally achieve the desired light effects. In addition to simulating the gravitationally affected falling object (such as the droplet of water falling from the icicle) and the rising object, (as in the firework shell embodiment), further novelty and uniqueness of the invention lies in the culminating splash in the icicle embodiment and exploding shower in the firework shell embodiment, produced by sequential operation of the on the multiplicity of outwardly positioned lights of the light blossom, such as established with LEDs strung on a blossom of ribbon wiring.

### BRIEF DESCRIPTION OF THE DRAWINGS

FIG. 1 is an elevation view of a first embodiment lighting system incorporating the unique aspects of the present invention.

FIG. 2 is an elevation view of a second embodiment lighting system incorporating the unique aspects of the present invention.

FIG. 3 is a view similar to FIG. 1 indicating a few selected light positions.

FIG. 4 is a block diagram representing operational and illumination control of the lighting systems shown in FIGS. 1 and 2.

FIG. 5 is a program flow diagram suitable for the block diagram shown in FIG. 4.

FIG. 6 is a block diagram representing alternate operational and illumination control of the lighting systems shown in FIGS. 1 and 2.

FIG. 7 is an elevation view of a alternate embodiment rising object lighting system with a simulated cannon shot, an invisible rise, and a top exploding light blossom.

FIGS. 8 and 9 are further implementations of the lighting system of FIG. 6, with multiple exploding firework light blossoms.

While the invention is susceptible of various modifications and alternative constructions, certain illustrated embodiments have been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DETAILED DESCRIPTION OF THE INVENTION

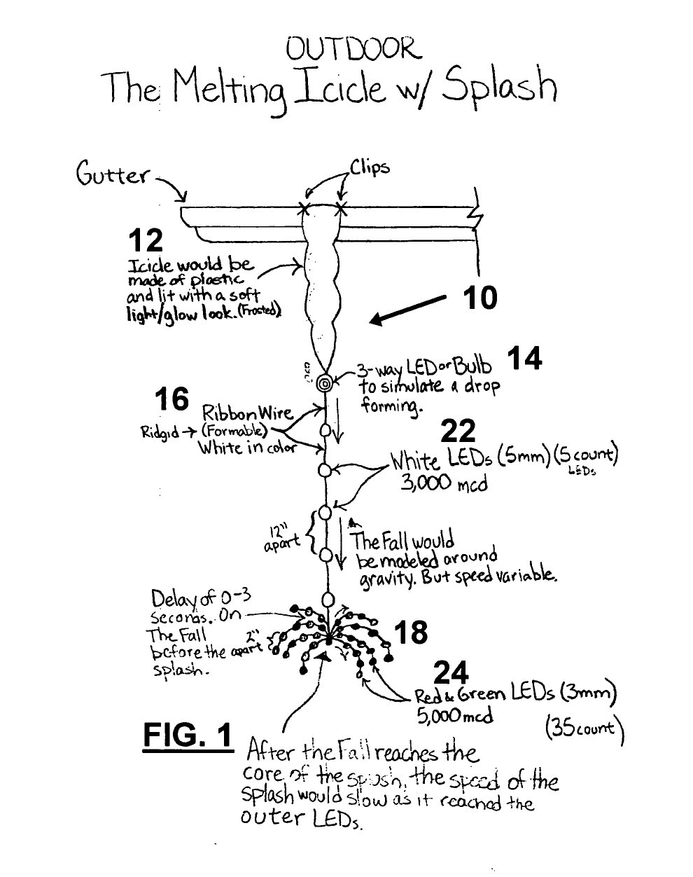

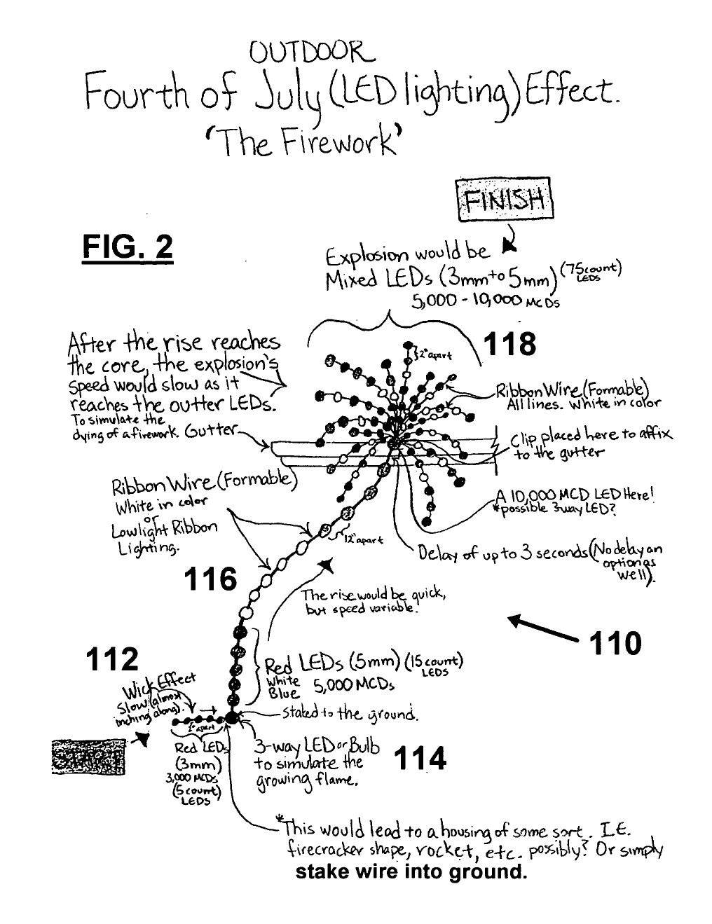

The present invention is shown in the drawings as embodied in an “icicle” light system 10 (FIG. 1), and in an alternate “firework” light system 110 (FIG. 2). The icicle light system 10 simulates the action of a drop of water developing at the end of a melting icicle, releasing and falling toward the ground, and producing a splash effect upon reaching the ground. The firework light system 110 simulates the action of a firework shell igniting, rising from the ground, and exploding into a shower of brilliant lights.

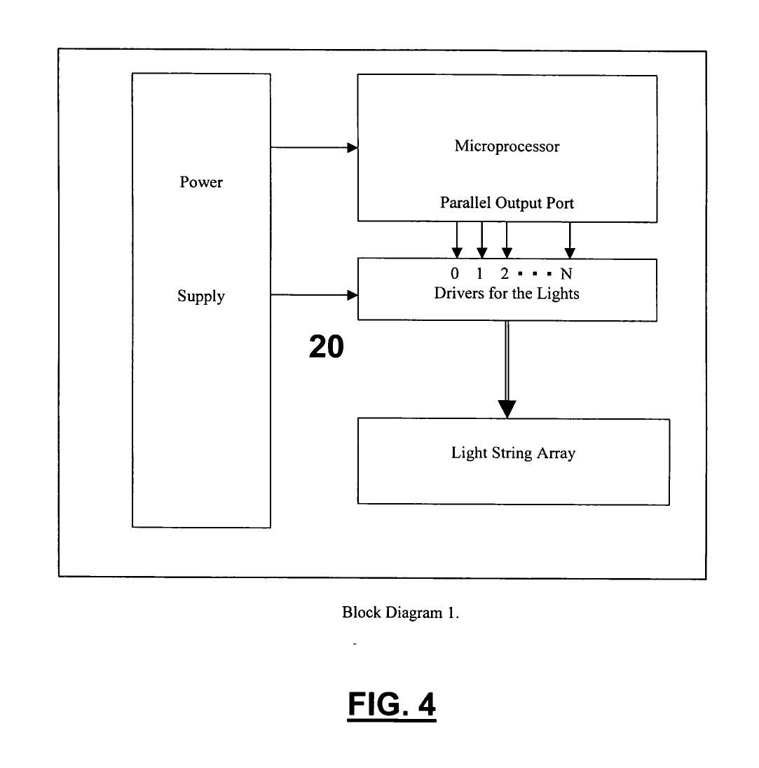

Referring to FIG. 1, the icicle system 10 includes an icicle 12, a drop-formation cluster 14, a light ribbon wire 16, a light blossom 18, and a power and control module 20 (FIG. 4). The icicle 12 is provided with a softly illuminated or glowing visual effect. The icicle is continuously illuminated, and is preferably made from a translucent, transparent or semi-opaque, optionally frosted, plastic material. The icicle may be solid or hollow, with illumination provided from a light source at the top of the icicle, or on the inside of the icicle. The drop-formation cluster 14 is positioned at the bottom tip of the icicle, and produces the simulated effect of formation of a drop of water at the end of the icicle. The light ribbon wire 16 hangs from the drop-formation cluster, and is provided with a series of spaced lights 22. Controlled, successive illumination of the lights on the ribbon wire 16 simulate the falling of the drop from the icicle to the ground. The light blossom 18 includes a multiplicity of light ribbon wires initiating proximate the center of the blossom established at the lower end of the light ribbon wire 16 and extending and terminating outwardly therefrom in a multiplicity of directions to establish the blossom form. The blossom light ribbons are provided with lights 24 spaced in relatively close proximity to one another, and illuminated in outward succession to simulate a splash when the simulated falling drop reaches the ground. The power and control module is connected and configured to provide electrical power for and timing of illumination of the icicle, the drop-formation cluster, the light ribbon wire 16 and the light blossom. The power source can include a relatively simple and inexpensive AC-DC power converter that can be plugged into a readily available AC power supply for continuous operation of the light system.

To establish one Christmas holiday visual effect, the drop-formation cluster 14 and spaced lights 22 illuminate white, and the lights 24 of the blossom illuminate red and green. Additional aspects of a Christmas holiday light system are noted in FIG. 1. Additional implementations of the invention will include visual effects modified, added to and/or deleted from the implementation shown.

The light ribbon wires described herein comprise electrical wires and connected lights. However, it will be understood that fiber optic bundles with spaced polished ends may be alternately used in place of the electrically connected lights within the scope of the invention, or other light transmission and end radiation means. In preferred embodiments, the lights designated herein are light emitting diodes (LEDs) to minimize power requirements and provide for good reliability and long life. However, it will also be understood that small light bulbs may be used in place of the LEDs without departing from the spirit of the invention.

The drop-formation cluster 14 is configured to simulate formation of a drop of water at the end of the icicle 12 by, for example, increasing the light intensity of the cluster over a period of time. The light intensity begins at an initial low level to simulate a small drop, or zero to simulate no drop, and increases to a higher intensity level, to simulate a growing drop until it reaches its desired size. Thereafter, the intensity of the cluster is quickly reduced, or entirely turned off, and falling of the drop is initiated.

The preferred drop-formation cluster includes a multiplicity of lights in a closely-packed arrangement. Formation of the drop is simulated by progressively illuminating an increasing number of the lights in the cluster until desired intensity is reached. Alternately, the drop-formation cluster includes at least one variable-intensity light that is progressively illuminated from the designated low level to the designated high level of intensity.

The effect of the falling drop is implemented utilizing either varied distances between the lights 22 in the ribbon wire 16, varied timing of equally spaced lights 22, or a combination thereof. Implementing the falling drop is discussed in detail below. The ribbon wire of lights semi-rigid to hold its shape under typically outside use conditions, but manually formable to establish the desired travel path for the drop.

The splash at the bottom of the center light ribbon wire 16 is implemented in the light blossom 18. As previously noted, the light blossom includes a multiplicity of light ribbon wires 18A initiating at the base of the light ribbon wire 16, and extending outwardly therefrom in a multiplicity of directions to establish the blossom. The light ribbon wires of the light blossom are preferable provided with relatively stiff construction, so that the blossom will hold its shape. This may be accomplished with, for example, either constructing the light ribbon wires from relatively stiff wire, or including stiffening wire bundled therewith. Generally circumferential, radially spaced light ribbon wires with additional LEDs may be optionally provided connecting the radial ribbon wires of the blossom, for stiffness and/or additional lighting availability purposes. The blossom light ribbons 18A are provided with lights 24 spaced in relatively close proximity to one another, and are illuminated in outward succession to simulate a splash when the falling drop reaches the ground.

The light blossom 18 may be constructed with alternate arrangements, such as utilizing a cast piece of plastic provided with spaced, wired lights, or which would pass the light from a central illumination source to the splash points placed at generally right angle to the viewer for maximum effect. Those skilled in the arts will readily devise alternate configuration light blossoms suitable for use in the present invention and in connection the control algorithms hereof.

The icicle 12 can be constructed with a fixed length, or alternately, with an adjustable telescoping length, to accommodate various distances from the icicle mounting location (e.g., the roof of gutter) to ground or other lower level. Simulating a real icicle with an undulating surface can be used to advantage in some implementations of the invention. If the internal surface of the icicle follows the undulations of the exterior, this can be used to advantage as resulting in a simpler plastic molding or other forming process to obtain a hollow icicle with a substantially constant-wall thickness.

The icicle can be provided with either a generally static visual presentation (continuously illuminated at a constant intensity), in combination with the developing drip at the bottom of the icicle, or with further visual impact as a “melting” icicle. To implement a melting icicle with simulated dripping drops, a single internal light source such as an intense LED, or a combination of LEDs may be used to produce light that is directed to succeeding portions of the icicle interior by one of several means. The interior undulations noted above will assist in enhancing the visibility of the light from the outside. One inexpensive and reliable means of directing the light would include means with a reflecting membrane acting as an internal mirror and arranged as part of a “Speaker Cone” type-configuration actuator which is driven electrically. With proper positioning of the light source and the speaker cone, the light is deflected from the membrane surface onto the interior of the icicle. Since the position of the speaker cone, and thus the mirror, is a function of the current flowing through the speaker coil, the position of the light beam reflected from the mirror can be controlled by said current. The light therefore can be selectively directed to any of a series of light receivers within the icicle, or otherwise positioned to receive the reflected light beam, which in turn transmit the light selectively into each of a series of light fibers. These fibers are arranged in a bundle, with individual fibers each terminating in a light radiating member to give the appearance of a light source analogous to the light emitting diodes previously mentioned. It will therefore be apparent to those skilled in the art that exactly the same visual effect can be created in this manner, utilizing light pipes, or optical fibers, to distribute light to the various radiating members instead of electrical signals to create the various points of light at the same positions. As described previously for the multiple light source embodiment, the position of the coil can be controlled either by a computer, by a shift register or equivalent control means with appropriate drive electronics . The descent of the “drop of light” along the fiber bundle is therefore directly controllable by the electrical control means.

An additional possibility with this implementation is the time multiplexing of the drop positioning signal with an “icicle light bathing signal”. In this embodiment a portion of the control cycle time is devoted to a rapidly varying electrical signal that is used to sweep the interior surface of the icicle. The rest of the cycle is devoted to focusing the light on a specific light receiver. This takes place at a cycle rate that is high enough to eliminate the blinking effect discernible by the human eye. Thus the entire light effect can potentially be achieved with a single light source, thereby reducing the cost of the system.

The power and control arrangements for this implementation is extremely simple and inexpensive. The power source for the LED arrangement could be an inexpensive, readily available AC-DC power converter. The speaker coil can be specified to draw a small current such as approximate a milliampere. The electronics required to drive the arrangement can be a simple pair of shift registers driven by a suitable oscillator.

Alternately, for example, a melting icicle can be simulated with the hollow plastic icicle shape and a readily available string of sequencing Christmas lights. The inside of the hollow icicle is provided so that there are attachment points for the light string allowing them to be placed inside the icicle, and sequenced lighting of the lights controlled by the control module of the light system. Even though the light string could be secured around the icicle, internal position of the light string is preferred as the plastic material of the icicle will diffuse the point source of each light on the string of lights.

With the foregoing arrangement, the icicle lighting system 10 operates to simulate an icicle that forms and drips a parade of drops of light which splash onto and outwardly on the ground.

The following description of the control module is a specific implementation of the invention. The control module includes an algorithm for individually controlling the on-off states of the lights, and is under control of a microcomputer or microchip that controls a set of light drivers through an appropriate interface, such as a parallel port, to power the lights. The microcomputer is programmed to output, in sequence, a series of light states through the parallel port. These states are contained in an array of predetermined values such as shown in TABLE 1 presented below. The time between output actions is predetermined so that the output actions occur at a predictable rate, thereby sequentially operating the individual lights to create the desired effect.

TABLE 1

| Time (second) | Position of “Drop” (inches) | Output State |
|---|---|---|
| 0.0 | 0.00 | 10000000000 |
| 0.1 | 1.92 | 01000000000 |
| 0.2 | 7.68 | 00100000000 |
| 0.3 | 17.28 | 00010000000 |
| 0.4 | 30.72 | 00001000000 |
| 0.5 | 48.00 | 00000100000 |
| 0.6 | 69.20 | 00000010000 |
| 0.7 | 94.08 | 00000001000 |
| 0.8 | 122.88 | 00000000100 |
| 0.9 | First Splash Ring | 00000000010 |
| 1.0 | Second Splash Ring | 00000000001 |
| 1.1 | Maximum Value | 00000000000 |

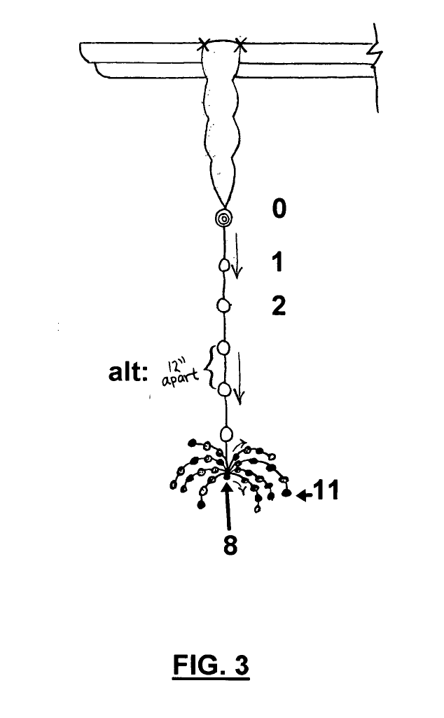

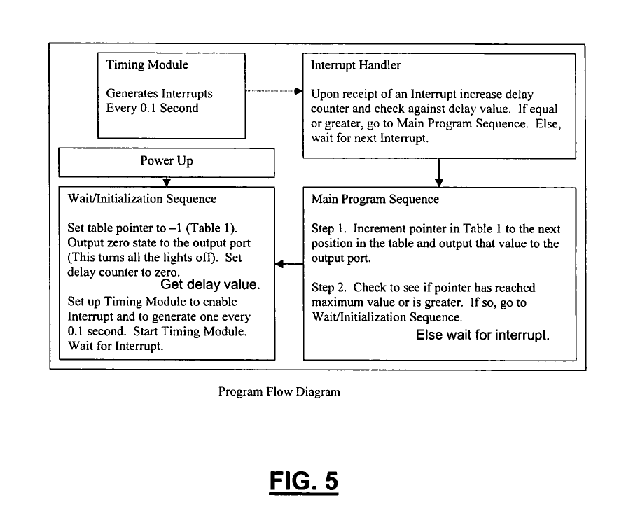

Referring to the implementation shown in the Program Flow Diagram (FIG. 5) and Block Diagram 1 (FIG. 4), at time t=0, the control program sets the parallel port to the state contained in Table 1, position 0, which is 100000000000. This action will turn on the light at position 0 as illustrated in FIG. 3. At time t=0.1 (i.e., at the next time increment), the program sets the port to the state contained in Table 1, position 1, which is 010000000000. This action will turn the light at position 0 off and the light at position 1 on, thereby producing the effect of the light “jumping from position 0 at the tip of the icicle to position 1 which, in this embodiment, is at, 1.92 inches below the light at position 0. At time t=0.2, the next state array (position 2 in Table 1) is output which turns on the light at position 2 and turns off the light at position 1. Since light #2 is positioned, in this embodiment, at 7.68 inches below position 0, the “drop will be perceived as having accelerated by gravity.

This process continues at ever increasing distances, calculated by the well known distance formula: distance=one half times acceleration times the square of elapsed time. For this embodiment, these distances are built into a cable of conductors that suspends from the tip of the icicle (position 0 in FIG. 1). It should be understood that the implementation could also employ a configuration utilizing constant distances with variable timing, or a combination of these embodiments.

When the “drop of light” meets the ground (at a distance of approximately 10 feet in the present embodiment), the output sequence continues as before. At time t=0.8 s, the parallel port receives the bit array of 000000001000. This will turn off the light at position 7 in FIG. 1 and turn on a group of diodes (for example 5 diodes) in a tight circle, less than 2 inches in diameter, to simulate the “water drop striking the ground. At time t=0.9 s, the parallel port receives the bit array of 000000000100 which turns off the initial splash diode set and turns on the first droplet circle (diameter approximately 10 inches, as indicated in FIG. 1.). In similar fashion, at time t=1.0 s, the controller turns off the 10 inch droplet circle and turns on the 20 inch diameter droplet circle by outputting 00000000010. Finally at time t=1.1 s the controller outputs 000000000000 to turn off all lights and enters a predetermined wait period before initiating a new cycle. The process and cycles continue while power is applied to the unit.

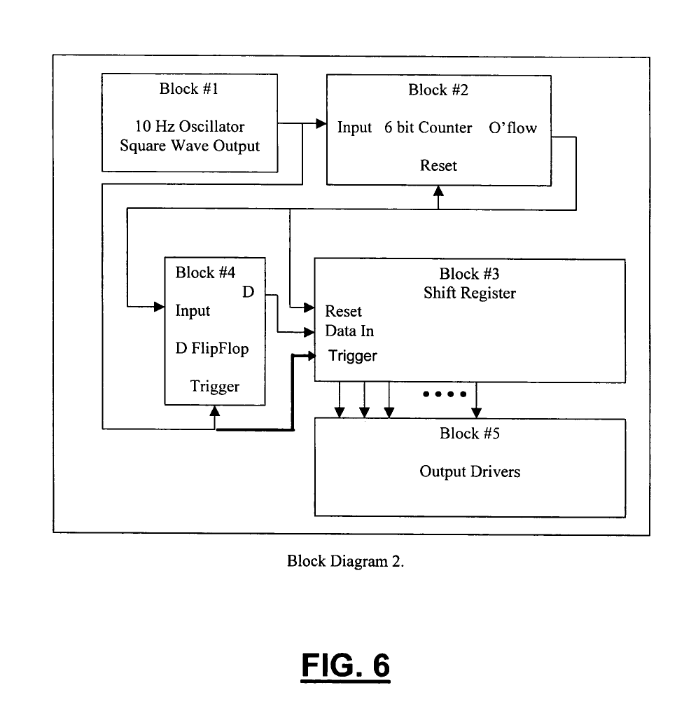

Those individuals who are skilled in the art can easily see that this is only one of several possible realizations of the invention. For another implementation possibility refer to Block Diagram 2 (FIG. 6). It will be understood that a power supply such as in Block Diagram 1 will be utilized here as well. In this instance, Block #1 is an oscillator that produces an alternating sequence of ones and zeros at a rate of, for example 10 HZ. This square wave signal is directed to a counter, Block #2, a six bit counter that is free running. This signal is also directed to a shift register, Block #3, to trigger a right shift at each clock cycle. The outputs of the shift register are connected to the light drivers, Block #4, as in the previous realization (Block Diagram 1). The overflow bit on the counter (Block #2) produces a reset signal for the entire circuit except for the flip flop (Block #5). This reset signal is connected to the D input (as a set signal) for the flip flop, raising the data out signal to a 1 which is connected to the input of the left-most bit of the shift register. When the clock signal arrives at the shift register, this 1 is shifted into the shift register. The next change of phase on the clock signal resets the flip flop to a 0 output state where it remains until it receives another 1 from the overflow bit from the counter. It is understood that logic timing must be accommodated in this embodiment to avoid logic race conditions.

The sequence begins when the overflow bit on the counter goes high. This triggers the set bit on the flip flop to provide a one for shifting into the shift register. Ensuing clock cycles cause the one to “walk” through the shift register, sequentially turning on the lights as described in the first realization.

It is also possible to implement this invention as an array of lights whose outputs are transmitted via fiber optic strands to radiating bulbs at the ends of the optical fibers.

In development of the invention, a cable was constructed to demonstrate the functional operation of the “Dripping Icicle” embodiment.

TABLE 2

| | distance (d) | time (t) | # of |
|---|---|---|---|
| feet | inches | second | Diodes |
| | | 0 | 3 |
| 0.16 | 1.92 | 0.1 | 1 |
| 0.64 | 7.68 | 0.2 | 1 |
| 1.44 | 17.28 | 0.3 | 1 |
| 2.56 | 30.72 | 0.4 | 1 |
| 4 | 48.00 | 0.5 | 1 |
| 5.76 | 69.12 | 0.6 | 1 |
| 7.84 | 94.08 | 0.7 | 1 |
| 10.24 | 122.88 | 0.8 | 5 |
| 12.96 | 155.52 | 0.9 | 5 |
| 16 | 192.00 | 1 | 5 |

In the foregoing table, a time increment of 0.1 seconds is used. The first “d” column sets forth the distance from the tip of the icicle to each light in units of “feet”, and the adjacent column provides the distance in inches. The last two rows in the table are not related to establishing the falling effect of the drop, but are instead the conductors to drive the splash lights, the yellow and blue (spdr for spider) conductors. The cable is expected to hang relatively straight—stiffener wires will probably be required to shape the splash array. The cable is wired for a splash of 5 legs—fewer may be used if desired. The wires are color coded to facilitate hook-up to the driver circuitry. The diodes were soldered directly to the pre-tinned terminal locations on the cable. The common conductor was exposed and tinned at the distances listed to facilitate soldering of the common legs of the diodes. The other leg of each diode is soldered to the end of the corresponding wire in the cable bundle. The splash consists of three rings of diodes attached to the spider legs. Five positions are available at each diameter. The blue ring is approximately 2 inches in diameter, the yellow ring is approximately 10 inches in diameter and the blue spdr ring is about 20 inches in diameter.

The core of the cable is a two conductor wire. One of these was marked to indicate that it is the common return for all diodes. The other conductor drives the inner blue ring of the splash. Maximum current load occurs when the three spider rings are active. This will provide a current of 100 ma in the common return line. The resistance of this line was measured to be 0.2 ohms, resulting in a voltage drop of 20 mV.

Two basic methods for implementing control of the light system are noted and described above. However, it will be understood by those skilled in the art that control of the light systems to achieve the desired visual effects may be implemented with alternate techniques readily available or determinable to those skilled in the relevant art.

For simulation, prototype and development purposes, and as a visualization and marketing tool, a simulating program is developed in which the two control methods are implemented in a single table-driven electronic control module, with the driving table being selectable by the user at initialization of the control program. The driving table provides the control module with a table of turn-on times for the lights. The final table entry is larger than two seconds and provides two functions to the visual implementations. The final table entry provides an indicator to the control module that the end of the cycle has arrived, and the final table entry provides the delay time between ending of one cycle and initiation of the next cycle.

The first control algorithm utilizes a constant time increment between lighting of adjacent LEDs for the falling action in the icicle light system. The acceleration effect is achieved by varying the spacing of the lights. The inter-light distance “d” is varied according to d=½ g [2 ((sum)Σ Δt)−Δt+Δt²)] where g=acceleration due to gravity, t is time in seconds, and Δt is the time increment between flashes in adjacent LEDs.

The second control algorithm utilizes constant distances between LEDs, and varies the time increment between successive flashes to produce the illusion of acceleration. In this case, if the lights are spaced at 1 foot distance, for example, the lights may turn on according to the following schedule:

| Release of drop | | | Dwell time |
|---|---|---|---|
| Light #1 | at | 0 seconds | .15 |
| Light #2 | at | 0.25 seconds | .05 |
| Light #3 | at | 0.353 seconds | .04 |
| Light #4 | at | .433 seconds, etc. | |

The simulation program will have the facility to vary the dwell time as well as to measure that effect on the illusion of motion. This will be implemented as adjunct table (above) that carries the on time for each of the output states.

The program will execute, for example, once each 0.02 seconds and output the on/off states for the individual lights at the same rate. The output states will remain at the previous state unless altered by the program. The control module will store the output states in an interface register at the beginning of each calculation cycle and immediately set an output interrupt request (OIR) to assure an even update rate.

The storage of the states in the control module register allows for multiple users of the outputs, such as use of a driver for a computer display screen and a driver for a parallel output port. These modules are triggered by the OIR, and will allow the control program to drive a light display system and/or simulate visual performance of the light system on a computer display.

The computer screen driver will cause the output state array to drive a table of pixels that has been predefined to give the desired appearance. It is anticipated that multiple tables of pixels will be required for simulation, experimentation, implementation and development purposes. Therefore consideration would be given to the ease of modification and table selection during initialization of the simulation program.

The output state array may contain, for example, 128 separate states for the simulation/operation program. The parallel port driver will transfer the output state array to the parallel port, with appropriate power amplification considerations, to subsequently drive the light system.

Sample acceleration based calculations for the light system, with ½ ∇t²=distance D, and a=g=32 ft/s²:

| | | | |
|---|---|---|---|
| if d | “F” then t | 0.707107 | 8 |
| | | 0.790569 | 10 |
| | | 0.866025 | 12 |
| | | 0.935414 | 14 |
| | | 1 | 16 |
| | | 0 | |
| | | 0.25 | 1 |
| | | 0.353553 | 2 |
| | | 0.433013 | 3 |
| | | 0.5 | 4 |
| | | 0.559017 | 5 |
| | | 0.612372 | 6 |
| | | 0.661438 | 7 |
| | | 0.707107 | 8 |
| | | 0.75 | 9 |
| | | 0.790569 | 10 |
| | | 0 | |
| | | 0 | |

The dwell time, LED spacing, and other considerations will be established to achieve the desired visual effect of the falling drop.

Referring to FIG. 2, the firework light system 110 includes a wick 112, a flame-formation cluster 114, a center light ribbon wire 116, one or more light blossoms 118, and a power and control module. As those skilled in the arts will recognize, many of the aspects of the “falling object” icicle light system 10 are applicable to the “rising object” firework system 110. Further details of the various components are shown in FIG. 2. Implementation of the control algorithm for the firework light system will operate virtually identically to the falling drop in the icicle system, except that, of course, the rising firework will visually decelerate as it rises. It is further noted that the firework “explosive” light blossom(s) radiates outwardly in substantially 360 degrees, whereas the splash blossom simulated the drop landing on a surface, and the outer lights on the firework blossom may be controlled with a decreasing intensity, as well as slowing speed, to simulate the “dying” of a firework.

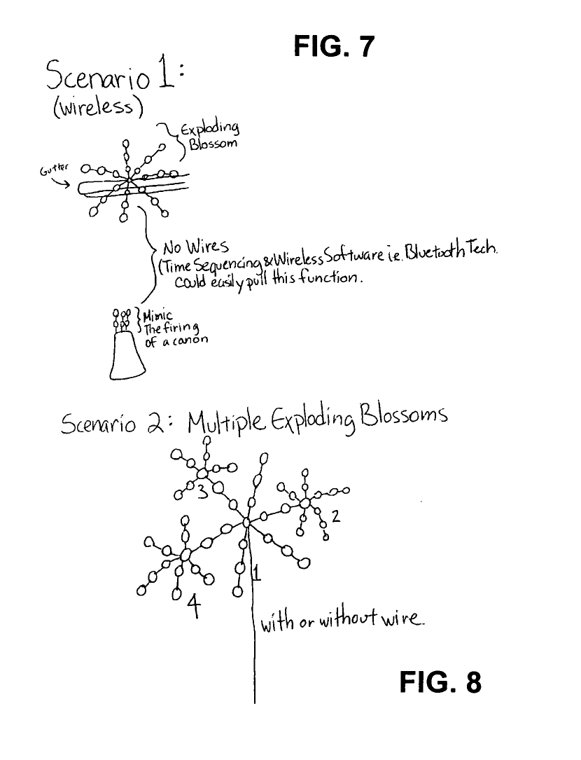

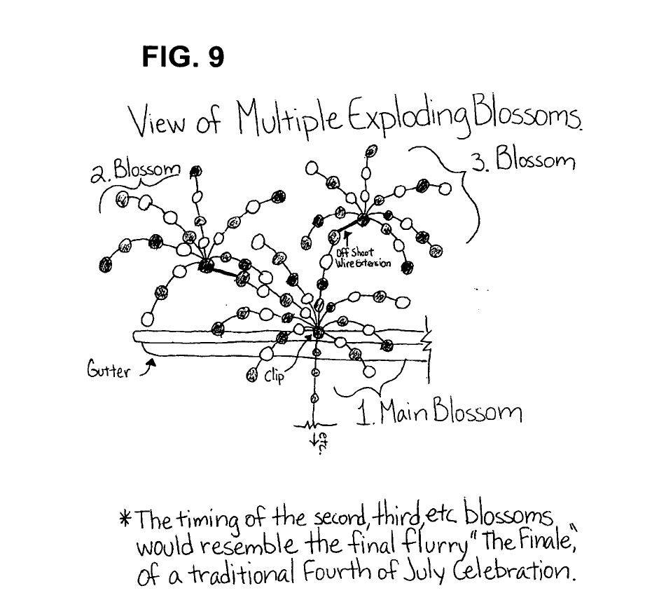

In an alternate embodiment shown in FIG. 7, a lighting system includes a simulated cannon shot with an exploding light array at the top, In this instance, the rise of the simulated cannon shot is not seen, but the invisible rise of the shot is a time dependent function simulating speed and affect of gravity, and the explosion is implemented in a light blossom as previously described. As shown in FIGS. 8 and 9, the simulated firework lighting system may also include multiple exploding light blossoms wired in parallel, is series, of a combination thereof. Additional creative alternate embodiment of the invention will be implements by those skilled in the arts. For example and without limitation, the fall or rise could be hung/mounted/started, etc. from a different object other than an icicle or firework shell, such as drops off tips of an umbrella with the culminating splash. The time dependent function of the rise or fall of the simulated object can vary other than associated with the simulated acceleration of gravity, such as twice the acceleration of gravity, half the acceleration of gravity, or other similarly suitable time dependent motion function.

1. A decorative light system comprising:
a) a generally vertical ribbon provided with spaced light radiation means along the length thereof,
b) a light initiation sequence at one end of the ribbon,
c) a light blossom at the other end of the ribbon, the light blossom including a multiplicity of lights spaced radiating outwardly from the end of the ribbon, and
d) a control module with three sequential operating modes operative to, in turn,
i) illuminate the light initiation sequence,
ii) sequentially light the spaced lights on the ribbon simulating an object in motion and under the influence of a time dependent function, and
iii) sequentially illuminate the lights of the light blossom outwardly from the end of the ribbon, again, sequentially as determined by a time dependent function.
